(19) United States
(12) Patent Application Publication
(10) Pub. No.: US 2017/0193518 A1
(43) Pub. Date: Jul. 6, 2017

(54) Electronic Card Application Method and Apparatus

(71) Applicant: ZTE CORPORATION, Hi-Tech Industrial Park, Nanshan Distric (CN)

(72) Inventors: Li YUE, Shenzhen (CN); Xin JIA, Shenzhen (CN)

(21) Appl. No.: 15/321,195

(22) PCT Filed: Aug. 19, 2014
(86) PCT No.: PCT/CN2014/084732

§ 371 Date: Mar. 2, 2017

(30) Foreign Application Priority Data
Jun. 24, 2014 (CN) 201410286202.7

(51) Int. Cl. G06Q 20/40; H04L 29/06; H04L 9/32; G06Q 20/32; H04W 12/12; H04W 4/00; G06Q 20/34; G06Q 20/10; G06Q 20/36; H04W 12/06

(52) U.S. Cl. CPC G06Q 20/40975; G06Q 20/3674; H04L 63/0853; H04L 9/3234; H04W 12/06; H04W 12/12; H04W 4/008; G06Q 20/351; G06Q 20/353; G06Q 20/352; G06Q 20/105; G06Q 20/3227; G06Q 20/3278; G06Q 20/322; G06Q 20/409

(57) ABSTRACT

An electronic card application method and device are provided, which relate to the technical field of communication, and can greatly improve efficiency and convenience of applying an electronic card by a user. The method includes that: a mobile terminal sends user identity information and encrypted function information corresponding to the user identity information to service equipment, herein, the user identity information and the encrypted function information are set in the mobile terminal in an electronic card form respectively; the mobile terminal provides a user confirmation interface corresponding to the encrypted function information for the user under the condition that the user identity information and the encrypted function information pass an authentication of the service equipment; and the service equipment is notified to execute an operation corresponding to the encrypted function information under the condition that a confirmation of the user is obtained.

### TECHNICAL FIELD

The present disclosure relates to the technical field of communication, and more particularly to an electronic card application method and device.

### BACKGROUND

In people's daily life, people are required usually to recharge corresponding cards at fixed sites for water purchasing, electricity purchasing and the like. A user who forgets to take cards may not complete the purchasing. Therefore, there is great inconvenience for people.

In addition, paying by card swiping has become very common, which avoids people going outside with a large sum of cash and brings great convenience to people's life. However, since a user usually has multiple bankcards or credit cards, and balance condition and consumption condition of each card may be different, for meeting requirements of various places, the user is usually required to take multiple cards and find a required card therein for checkout. Moreover, more and more merchants establish member systems and issue their own member cards to members, and a user is usually required to show a member card of a merchant to enjoy member service such as credit addition and discounting during payment. Therefore, the user has to rummage in a bag for various member cards and bank cards during checkout, which is inconvenient and also wastes time.

For all kinds of inconvenience brought to people by various user identity related cards and corresponding operations in life, there is yet no good solution in a related technology.

### SUMMARY

A technical problem to be solved by embodiments of the present disclosure is to provide an electronic card application method and device to solve the problem of application inconvenience brought to people by various user identity related cards and corresponding operations in the related technology.

In order to solve the abovementioned technical problem, the following technical solutions are adopted.

An electronic card application method includes that the following steps.

User identity information and encrypted function information corresponding to the user identity information are set in a mobile terminal in an electronic card form respectively.

The mobile terminal sends the user identity information and the encrypted function information to service equipment.

The mobile terminal provides a user confirmation interface corresponding to the encrypted function information for a user under a condition that the user identity information and the encrypted function information pass an authentication of the service equipment.

The mobile terminal notifies the service equipment to execute an operation corresponding to the encrypted function information under a condition that a confirmation of the user is obtained.

In an exemplary embodiment, the manner of sending, by the mobile terminal, the user identity information and the encrypted function information to service equipment includes at least one of the following manners:

sending through Near Field Communication NFC equipment, sending through Bluetooth equipment, sending through infrared equipment and sending through Wireless Fidelity WIFI equipment.

In an exemplary embodiment, the user confirmation interface includes a password input field.

In an exemplary embodiment, after the mobile terminal provides the user confirmation interface corresponding to the encrypted function information for the user, the method further includes that:

a setting interface is provided for the user to re-determine encrypted function information corresponding to the user identity information according to an input setting of the user under a condition that the confirmation of the user is not obtained.

In an exemplary embodiment, the user identity information is an identifier that can identify an identity of the user; and the encrypted function information includes one or more pieces of the following information: bankcard payment function information, Subscriber Identity Module SIM card payment function information, or room unlocking function information, member information query function information, gift exchange function information and service changing function information.

An electronic card application method includes that the following steps.

Service equipment receives user identity information and encrypted function information corresponding to the user identity information, which are sent by a mobile terminal.

The mobile terminal is notified to provide a corresponding user confirmation interface for a user under a condition that the user identity information and the encrypted function information pass an authentication of the service equipment.

The service equipment executes an operation corresponding to the encrypted function information under a condition that a confirmation of the user is obtained.

In an exemplary embodiment, a manner of receiving, by service equipment, user identity information and encrypted function information corresponding to the user identity information, which are sent by a mobile terminal, includes at least one of the following manners:

sending through Near Field Communication, NFC, equipment, sending through Bluetooth equipment, sending through infrared equipment and sending through Wireless Fidelity, WIFI, equipment.

In an exemplary embodiment, after the service equipment receives the user identity information and the encrypted function information corresponding to the user identity information, which are sent by the mobile terminal, the method further includes:

the service equipment comparing the received user identity information with an identity information table of all registered users maintained in the service equipment, and if the information is matched, determining that an authentication is passed; or, the service equipment comparing the received user identity information with the identity information table of all registered users maintained in the service equipment, and if the information is matched and a security authentication on the user identity information and the corresponding encrypted function information is passed, determining that the authentication is passed.

In an exemplary embodiment, the service equipment is payment equipment, and under a condition that a confirmation of the user is obtained, the service equipment executing an operation corresponding to the encrypted function information includes:

the payment equipment receiving a password input by the user from the mobile terminal, and after the password is authenticated to be correct, the payment equipment completing a deduction operation over a bankcard.

In an exemplary embodiment, after the deduction operation over the bankcard is completed, the method further includes:

completing a member card credit upgrading operation.

An electronic card application device, arranged in a mobile terminal, includes a configuration unit, a sending unit, a provision unit and a terminal notification unit. Herein:

The configuration unit is arranged to set user identity information and encrypted function information corresponding to the user identity information in the mobile terminal in an electronic card form respectively.

The sending unit is arranged to send the user identity information and the encrypted function information to service equipment.

The provision unit is arranged to provide a user confirmation interface corresponding to the encrypted function information for a user under a condition that the user identity information and the encrypted function information pass an authentication of the service equipment.

The terminal notification unit may be arranged to notify the service equipment to execute an operation corresponding to the encrypted function information under a condition that a confirmation of the user is obtained.

In an exemplary embodiment, the user confirmation interface provided by the provision unit includes a password input field.

In an exemplary embodiment, the provision unit is further arranged to provide a setting interface for the user to re-determine encrypted function information corresponding to the user identity information according to an input setting of the user under a condition that the confirmation of the user is not obtained.

In an exemplary embodiment, the sending unit is arranged to send the user identity information and the encrypted function information to the service equipment in at least one of the following manners:

sending through NFC equipment, sending through Bluetooth equipment, sending through infrared equipment and sending through WIFI equipment.

An electronic card application device, arranged in service equipment, includes a receiving unit, an equipment notification unit and an execution unit. Herein:

The receiving unit is arranged to receive user identity information and encrypted function information corresponding to the user identity information, which are sent by a mobile terminal.

The equipment notification unit is arranged to notify the mobile terminal to provide a corresponding user confirmation interface for a user under a condition that the user identity information and the encrypted function information pass an authentication of the service equipment.

The execution unit is arranged to execute an operation corresponding to the encrypted function information under a condition that a confirmation of the user is obtained.

According to the electronic card application method and device adopting the technical solutions, the user identity information and the corresponding encrypted function information are both stored in the mobile terminal, and the mobile terminal may send the information to the corresponding service equipment. The mobile terminal can further provide the user confirmation interface corresponding to the encrypted function information for the user after the service equipment authenticates the information The mobile terminal notifies the service equipment to make the service equipment execute the operation corresponding to the encrypted function information under the condition that the confirmation of the user is obtained. In such a manner, the user identity information and some function information corresponding to the identity information are all integrated in the mobile terminal such as a mobile phone of the user. During application, the service equipment may automatically perform a security authentication on the identity information and the corresponding function information, and then automatically ask for the confirmation of the user. The user can execute an operation with a legal identity to complete a corresponding function without sequentially showing a corresponding identity card and function card. Therefore, efficiency and convenience of applying an electronic card by the user are greatly improved.

### BRIEF DESCRIPTION OF DRAWINGS

FIG. 1 is a flowchart of an electronic card application method provided in an embodiment of the present disclosure.

FIG. 2 is another flowchart of an electronic card application method provided in an embodiment of the present disclosure.

FIG. 3 is a structure diagram of an electronic card application device provided in an embodiment of the present disclosure

FIG. 4 is another structure diagram of an electronic card application device provided in an embodiment of the present disclosure.

FIG. 5 is a structure diagram of a member card application device for an intelligent terminal provided in an embodiment of the present disclosure.

FIG. 6 is a structure diagram of a card swiping interaction device for a merchant provided in an embodiment of the present disclosure.

FIG. 7 is a schematic diagram of a connection relationship of a card swiping interaction device for a merchant according to an alternative embodiment of the present disclosure.

FIG. 8 is a flowchart of interaction between a member card application device for an intelligent terminal and a card swiping interaction device for a merchant according to an alternative embodiment of the present disclosure.

FIG. 9 is a detailed flowchart of performing a member authentication and payment operation through a network according to an alternative embodiment of the present disclosure.

### SPECIFIC EMBODIMENTS

The present disclosure will be described below with reference to the drawings in detail. It should be understood that specific embodiments described here are only adopted to explain the present disclosure but not intended to limit the present disclosure.

As shown in FIG. 1, an embodiment of the present disclosure. provides an electronic card application method. The method includes the following steps.

In step S11, user identity information and encrypted function information are set respectively in a mobile terminal in an electronic card form.

In step S12, the mobile terminal sends the user identity information and the encrypted function information corresponding to the user identity information to service equipment.

In step S13, the mobile terminal provides a user confirmation interface corresponding to the encrypted function information for a user under the condition that the user identity information and the encrypted function information passed an authentication of the service equipment.

In step S14, the mobile terminal notifies the service equipment to execute an operation corresponding to the encrypted function information under the condition that a confirmation of the user is obtained.

According to the electronic card application method and device provided by embodiments of the present disclosure, the user identity information and the corresponding encrypted function information are both stored in the mobile terminal, and the mobile terminal may send the information to the corresponding service equipment. The mobile terminal can further provide the user confirmation interface corresponding to the encrypted function information for the user after the service equipment authenticates the information. The mobile terminal notifies the service equipment to make the service equipment execute the operation corresponding to the encrypted function information under the condition that the confirmation of the user is obtained. In such a manner, the user identity information and some function information corresponding to the identity information are all integrated in the mobile terminal such as a mobile phone of the user. During application, the service equipment may automatically perform a security authentication on the identity information and the corresponding function information, and then automatically ask for the confirmation of the user. The user can execute an operation with a legal identity to complete a corresponding function without sequentially showing a corresponding identity card and function card. Therefore, efficiency and convenience of applying an electronic card by the user are greatly improved.

In an exemplary embodiment, the manner in which the mobile terminal sends the user identity information and the encrypted function information corresponding to the user identity information to the service equipment includes at least one of the following manners: sending through NFC equipment, sending through Bluetooth equipment, sending through infrared equipment and sending through WIFI equipment. No matter which manner is adopted for sending, it is only required to arrange corresponding devices on the mobile terminal and the service equipment. The manner is not limited in embodiments of the present disclosure.

Specifically, the user identity information and the encrypted function information corresponding to the user identity information may be stored in a chip of the mobile terminal as a small database. A specific data structure of data in the database is not limited. For example, in an embodiment of the present disclosure. the user identity information may be set as a data table similar to a contact list, while all the encrypted function information is set as another data table, and the two data tables have a certain mapping relationship. Thereby, the user identity information and the encrypted function information correspond to each other.

In an exemplary embodiment, the user identity information may be an identifier that can identify an identity of the user. For example, a water card sequence number of a water purchasing user, an electricity card sequence number of an electricity purchasing user, a member card number of a user shopping in a shop and even an access control card sequence number of a room occupant and the like. Then, the corresponding encrypted function information may be bankcard payment function information, Subscriber Identity Module SIM card payment function card, or room unlocking function information and the like, which is not limited in embodiments of the present disclosure.

The electronic card application method provided by the present disclosure will be described below with the condition that the user identity information is electronic member card information and the corresponding encrypted function information is bankcard swiping consumption function information as an example in detail. Under water purchasing and electricity purchasing conditions, it is just required to replace a member card number with sequence numbers of a water card and an electricity card. When the user identity information is an access control card sequence number and the corresponding encrypted function information is room unlocking function information, it is only required to replace the member card number with the access control card sequence number and replace the bankcard swiping consumption function information with the room unlocking function information.

In an embodiment of the present disclosure, the user identity information is electronic member card information, the corresponding encrypted function information is bankcard swiping payment function information, and the service equipment is payment equipment. Then, when the user performs a checkout for shopping in a certain member shop, it is only required to move the mobile phone close to the payment equipment and start an electronic card application program, and in step S12, the mobile terminal will send the member card information and the bankcard payment function information bound with the member card to the payment equipment. Herein, the member card information may be information which is registered on the payment equipment of the shop previously. In step S13, the mobile phone of the user may provide a user confirmation interface corresponding to the bankcard swiping payment function information for the user under the condition that the member card information and the bankcard payment function information pass the authentication of the payment equipment. Herein, items such as a consumption sum and consumption details of the user may be displayed on the interface. The user may click a confirmation button to complete the transaction when confirming that the items such as the consumption sum and the details are correct. To further enhance security, in an exemplary embodiment, the user may further preset a transaction password, and under such a condition, the mobile terminal may further provide a password input field for the user. After the user inputs the correct password and clicks the confirmation button, in step S14, the mobile terminal may notify the payment equipment to make the payment equipment finish a deduction operation over the bankcard. Furthermore, after the deduction operation is finished, information such as credits corresponding to the member card of the user may further be updated, thereby finishing a member card credit upgrading operation.

Therefore, the user may store identity information of multiple members corresponding to multiple merchants frequently visited by the user and the like, and corresponding bankcard payment function information, in the mobile terminal such as the mobile phone. When the user consumes in different merchants, the corresponding member identity information and the corresponding bankcard payment function information may be called for service equipment of the merchants for the security authentication, the user is automatically asked for a confirmation. The transaction and corresponding operations such as member credits and the like may be completed in case of successful deduction after the user performs the confirmation. The user is not required to sequentially show corresponding the member card and bankcard. Therefore, efficiency and convenience of applying an electronic card by the user are greatly improved.

In an exemplary embodiment, under some conditions, the user may be intended to pay in cash, and a swiping payment function of a bankcard is not required to be bound with another member card. Therefore, the user is not required to click the confirmation button on the user confirmation interface. In an embodiment of the present disclosure, a setting interface is further provided for the user, and the user may click a “change the setting” button on the confirmation interface to enter the setting interface, to re-determine bankcard swiping payment function information (encrypted function information) corresponding to the member card information (user identity information) according to an input setting of the user.

Besides the condition that the encrypted function information in the embodiment is the bankcard swiping payment function information, the encrypted function information in other embodiments of the present disclosure may also be member information query function information, gift exchange function information, service changing function information and the like, which is not limited in the embodiment of the present disclosure.

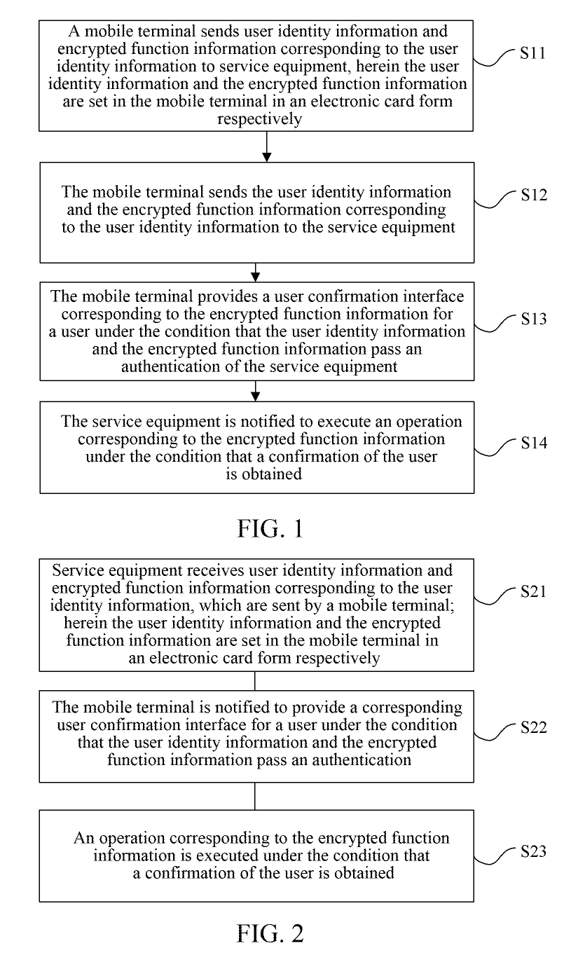

Correspondingly, as shown in FIG. 2, an embodiment of the present disclosure further provides an electronic card application method. The method includes the following steps.

In step S21, service equipment receives user identity information and encrypted function information corresponding to the user identity information, which are sent by a mobile terminal. Herein, the user identity information and the encrypted function information are set in the mobile terminal in an electronic card form respectively.

In step S22, the mobile terminal is notified to provide a corresponding user confirmation interface for a user under the condition that the user identity information and the encrypted function information pass an authentication.

In step S23, the service equipment executes an operation corresponding to the encrypted function information under the condition that a confirmation of the user is obtained.

According to the electronic card application method provided by the embodiment of the present disclosure, the service equipment can receive the user identity information and the encrypted function information corresponding to the user identity information from the mobile terminal, and the mobile terminal is notified to provide the corresponding user confirmation interface for the user under the condition that the user identity information and the encrypted function information pass the authentication, and the encrypted function information is executed under the condition that the confirmation of the user is obtained. In such a manner, the user identity information and some function information corresponding to the identity information are all integrated in the mobile terminal such as a mobile phone of the user. During application, the service equipment can receive user identity information and function information corresponding to the identity information from the mobile terminal such as a mobile phone or the like, and may automatically perform a security authentication on the identity information and the corresponding function information, and then wait for the confirmation of the user. The user can execute an operation with a legal identity to complete a corresponding function without sequentially showing a corresponding identity card and function card. Therefore, efficiency and convenience of applying an electronic card application by the user are greatly improved.

In an exemplary embodiment, the manner of receiving, by the service equipment, the user identity information and the encrypted function information corresponding to the user identity information from the mobile terminal includes one or more of the following manners: sending through NFC equipment, sending through Bluetooth equipment, sending through infrared equipment and sending through WIFI equipment. No matter which manner is adopted for sending, it is only required to arrange corresponding devices on the mobile terminal and the service equipment. The manner is not limited in the embodiment of the present disclosure.

An identity information table of all registered users is maintained in the service equipment, When a group of user identity information and encrypted function information corresponding to the user identity information are received from the mobile terminal, the received user identity information may be compared with the user identity information in the table, and if the two pieces of information are matched, it is indicated that the user identity information is correct and a subsequent operation may be executed. In addition, the service equipment may further perform other security authentication on the user identity information and the corresponding encrypted function information. A specific authentication process may refer to various authentication processes in the related technology, and will not be elaborated herein.

In an exemplary embodiment, the user identity information may be an identifier that can identify an identity of the user. For example, a water card sequence number of a water purchasing user, an electricity card sequence number of an electricity purchasing user, a member card number of a user shopping in a shop and even an access control card sequence number of a room occupant and the like. Then, the corresponding encrypted function information may be bankcard swiping payment function information, SIM card payment function card, or room unlocking function information and the like, which is not limited in embodiments of the present disclosure.

For example, in an embodiment of the present disclosure, the user identity information is electronic member card information, the encrypted function information is bankcard swiping payment function information, and the service equipment is payment equipment. Then, when the user performs a checkout for shopping in a certain member shop, it is only required to move the mobile phone close to the payment equipment and start an electronic card application program, and in step S21, the payment equipment receives the member card information and the bankcard swiping payment function information corresponding to the member card information from the mobile terminal. In step S22, the mobile terminal is notified to provide a corresponding user confirmation interface for the user under the condition that the member card information and the bankcard swiping payment function information pass the authentication. In Step 23, an operation corresponding to the bankcard swiping payment function information is executed under the condition that a confirmation of the user is obtained.

To further enhance security, in an exemplary embodiment, the user may further preset a transaction password, and under such a condition, the payment equipment may further receive a password input by the user from the mobile terminal, and after the password is authenticated to be correct, in step S23, the payment equipment finishes a deduction operation over the bankcard. Furthermore, after the deduction operation is finished, information such as credits corresponding to the member card of the user and the like may further be updated, thereby finishing a member card credit upgrading operation.

In such a manner, the user may store identity information of multiple members corresponding to multiple merchants frequently visited by the user and the like, and corresponding bankcard payment function information, in the mobile terminal such as the mobile phone. When the user consumes in different merchants, the corresponding member identity information and the corresponding bankcard payment function information may be called for service equipment of the merchants for the security authentication, the user are automatically asked for a confirmation. The transaction and corresponding operations such as member credits and the like may be completed in case of successful deduction after the user performs the confirmation. The user is not required to sequentially show corresponding the member card and bankcard. Therefore, efficiency and convenience of applying an electronic card by the user are greatly improved.

Besides the condition that the encrypted function information in the embodiment is the bankcard swiping payment function information, the encrypted function information in other embodiments of the present disclosure may also be member information query function information, gift exchange function information, service changing function information and the like, which is not limited in the embodiment of the present disclosure. The user may conveniently query all kinds of member information of the user or promotions of the merchants and the like, therefore applications of an electronic card are further enriched.

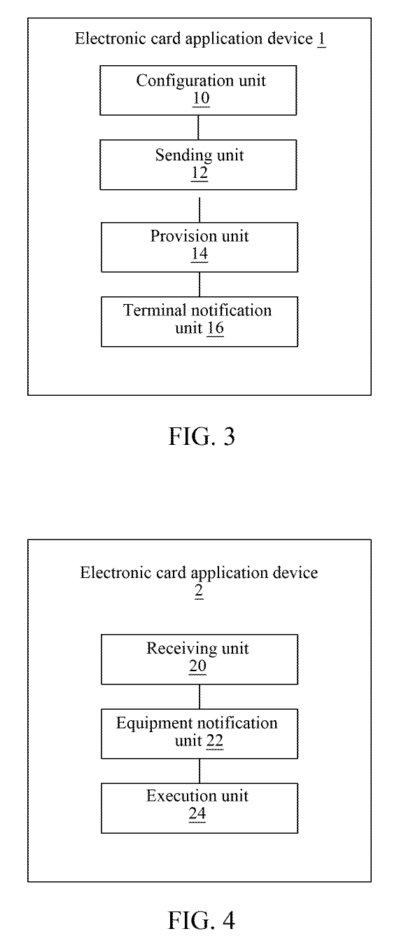

Corresponding to the abovementioned electronic card application method, an embodiment of the present disclosure further provides an electronic card application device, which is arranged in a mobile terminal, and as shown in FIG. 3, the electronic card application device 1 includes the following units.

A configuration unit 10 is arranged to set user identity information and encrypted function information corresponding to the user identity information in the mobile terminal in an electronic card form respectively.

A sending unit 12 is arranged to send the user identity information and the encrypted function information to service equipment.

A provision unit 14 is arranged to provide a user confirmation interface corresponding to the encrypted function information for a user under the condition that the user identity information and the encrypted function information pass an authentication of the service equipment.

A terminal notification unit 16 is arranged to notify the service equipment to execute an operation corresponding to the encrypted function information under the condition that a confirmation of the user is obtained.

According to the electronic card application device 1 provided by the embodiment of the present disclosure, the user identity information and the corresponding encrypted function information are both stored in the mobile terminal. The sending unit 12 may send the registered user identity information and the corresponding encrypted function information to the corresponding service equipment. The provision unit 14 can provide the user confirmation interface corresponding to the encrypted function information for the user after the service equipment authenticates the information. The terminal notification unit 16 can notify the service equipment to make the service equipment execute the encrypted function information under the condition that the confirmation of the user is obtained. In such a manner, the user identity information and some function information corresponding to the identity information are all integrated in the mobile terminal such as a mobile phone of the user. During application, the service equipment may automatically perform a security authentication on the identity information and the corresponding function information, and then automatically ask for the confirmation of the user. The user can execute an operation with a legal identity to complete a corresponding function without sequentially showing a corresponding identity card and function card. Therefore, efficiency and convenience of applying an electronic card by the user are greatly improved.

In an exemplary embodiment, the manner of sending, by the mobile terminal, the user identity information and the encrypted function information corresponding to the user identity information to the service equipment includes at least one of the following manners: sending through NFC equipment, sending through Bluetooth equipment, sending through infrared equipment and sending through WIFI equipment. No matter which manner is adopted for sending, it is only necessary to arrange corresponding devices on the mobile terminal and the service equipment. The manner is not limited in embodiments of the present disclosure

In an exemplary embodiment, the user identity information may be an identifier that can identify an identity of the user. For example, a water card sequence number of a water purchasing user, an electricity card sequence number of an electricity purchasing user, a member card number of a user shopping in a shop and even an access control card sequence number of a room occupant and the like. Then, the corresponding encrypted function information may be bankcard payment function information, member information query function information, SIM card payment function card, or room unlocking function information and the like, which is not limited in embodiments of the present disclosure. The corresponding service equipment may be payment equipment, information query equipment, a security door system and the like.

To further enhance security, in an exemplary embodiment, the user confirmation interface provided by the provision unit 14 further includes a password input field.

In an exemplary embodiment, the provision unit 14 may further be arranged to provide a setting interface for the user to re-determine encrypted function information corresponding to the user identity information according to an input setting of the user under the condition that the confirmation of the user is not obtained.

Correspondingly, as shown in FIG. 4, an embodiment of the present disclosure further provides an electronic card application device 2, which is arranged in service equipment, and the electronic card application device 2 may include the following units.

A receiving unit 20 is arranged to receive user identity information and encrypted function information corresponding to the user identity information, which are sent by a mobile terminal. Herein, the user identity information and the encrypted function information are set in the mobile terminal in an electronic card form respectively.

An equipment notification unit 22 is arranged to notify the mobile terminal to provide a corresponding user confirmation interface for a user under the condition that the user identity information and the encrypted function information pass an authentication.

An execution unit 24 is arranged to execute an operation corresponding to the encrypted function information under the condition that a confirmation of the user is obtained.

According to the electronic card application device provided by the embodiment of the present disclosure, the receiving unit 20 can receive the user identity information and the encrypted function information corresponding to the user identity information from the mobile terminal, and the equipment notification unit 22 can notify the mobile terminal to provide the corresponding user confirmation interface for the user under the condition that the user identity information and the encrypted function information pass an authentication, and the execution unit 24 can execute the operation corresponding to the encrypted function information under the condition that the confirmation of the user is obtained. In such a manner, the user identity information and some function information corresponding to the identity information are all integrated in the mobile terminal such as a mobile phone of the user. During application, the service equipment may receive user identity information and some function information corresponding to the identity information from the mobile terminal such as a mobile phone. The service equipment may automatically perform a security authentication on the identity information and the corresponding function information, and then automatically wait for the confirmation of the user. The user can execute an operation with a legal identity to complete a corresponding function without sequentially showing a corresponding identity card and function card. Therefore, efficiency and convenience of applying an electronic card by the user are greatly improved.

In an exemplary embodiment, the manner of receiving, by the service equipment, the user identity information and the encrypted function information corresponding to the user identity information from the mobile terminal includes one or more of the following manners: sending through NFC equipment, sending through Bluetooth equipment, sending through infrared equipment and sending through WIFI equipment. No matter which manner is adopted for sending, it is only necessary to arrange corresponding devices on the mobile terminal and the service equipment. The manner is not limited in embodiments of the present disclosure.

An identity information table of all registered users is maintained in the service equipment. When a group of user identity information and encrypted function information corresponding to the user identity information are received from the mobile terminal, the received user identity information may be compared with the user identity information in the table, and if the two pieces of information are matched, it is indicated that the user identity information is correct and a subsequent operation may be executed. In addition, the service equipment may further perform other security authentication on the user identity information and the corresponding encrypted function information. A specific authentication process may refer to various authentication processes in the related technology, and will not be elaborated herein.

In an exemplary embodiment, the user identity information may be an identifier that can identify an identity of the user. For example, a water card sequence number of a water purchasing user, an electricity card sequence number of an electricity purchasing user, a member card number of a user shopping in a shop and even an access control card sequence number of a room occupant and the like. Then, the corresponding encrypted function information may be bankcard swiping payment function information, SIM card payment function card, or room unlocking function information and the like, which is not limited in the embodiment of the present disclosure. The corresponding service equipment may be payment equipment, information query equipment, a security door system and the like.

To further enhance security, in an exemplary embodiment, the user may preset a password. Under the condition, the receiving unit 20 may further receive a password input by the user from the mobile terminal, and after the password is authenticated to be correct, the execution unit 24 finishes a deduction operation over the bankcard. Furthermore, after the deduction operation is finished, the execution unit 24 may further update information such as credits corresponding to the member card of the user and the like, thereby finishing a member card credit upgrading operation.

The electronic card application device provided by the present disclosure will be described below with specific embodiments in detail.

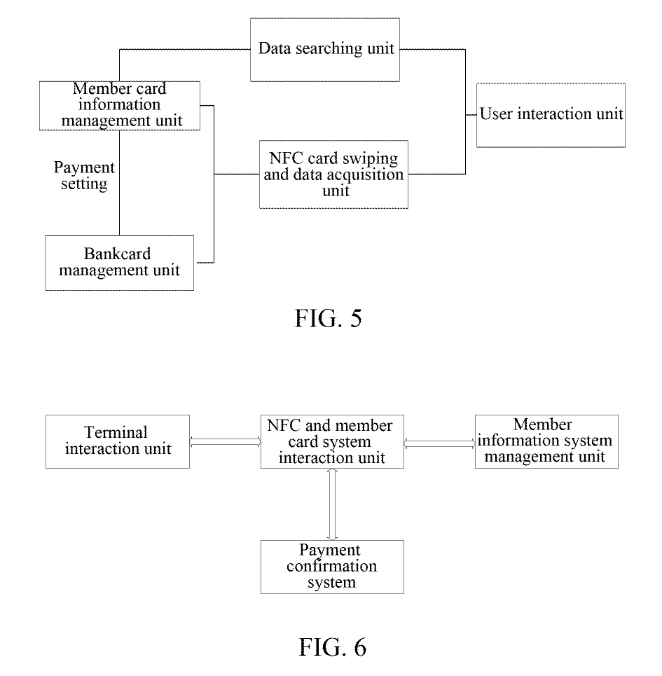

As shown in FIG. 5 and FIG. 6, an embodiment of the present disclosure provides a member card application device for an intelligent terminal and a card swiping interaction device for a merchant. Herein, the member card application device for the intelligent terminal in FIG. 5 is a specific implementation mode of the electronic card application device shown in FIG. 3, and the card swiping interaction device for the merchant in FIG. 6 is a specific implementation mode of the electronic card application device 2 shown in FIG. 4. In the embodiment of the present disclosure, one-step consumption of a consumer of the merchant is finished through the terminal device and the card swiping interaction device for the merchant. The consumer of the merchant is not required to take along multiple member cards, is also not required to look for different bankcards in a wallet for card swiping consumption during consumption. The consumer of the merchant may finish all consumption only by taking along the intelligent terminal after setting. Simply speaking, the consumer is only required to click a confirmation button, and all processing processes and security protection are implemented by the intelligent terminal and the card swiping interaction device for the merchant.

Specifically, the member card application device includes: an NFC card swiping and data acquisition unit, a member card information management unit, a bankcard management unit, a user interaction unit and a data searching unit.

Herein, the NFC card swiping and data acquisition unit is mainly arranged to perform a short distance communication with NFC equipment of the merchant to realize a bidirectional member card information input and member card information transmission function and finish a card swiping operation. Herein, transmitted information may include: member card credit information and associated payment manner information of a user. Specifically, the data transmission may be implemented through an NFC Controller Interface NCI. The process is totally transparent for the user, and the user is not required to pay attention to the process. The key is that a user card swiping information prompt may be provided on the mobile terminal after card swiping. The information prompt may be customized, which is not extended for description herein. The unit can control a card swiping flow and acquire corresponding card swiping data through a card swiping process. If necessary, the data may be interactively compared with data stored in the member card information management unit and the bankcard management unit, for example, matching of the member card information and whether a bankcard and a corresponding member card are bound for direct payment, and final correct data are transmitted to the user interaction unit in a visual form, and processed for final processing by a terminal owner.

Of course, the terminal owner may also search the user interaction unit for information through a visual User Interface UI by virtue of the data searching unit, the information includes member card information query, bankcard information query and the like. The member card information may usually include: a member card number, a user name, a corresponding telephone number, a merchant name, and extended information such as credit query, card swiping record and promotional information and the like. The information may be maintained through a contact list. In an exemplary embodiment, on the basis, a function of supporting information in a multimedia message format may further be added to display and query the extended information.

The member card information management unit mainly stores various kinds of member card information of the user, for example, a member card of the Kaiyuan Shopping Mall, a member card of Jinhua and a member card of Yupinxuan. The member card information may be processed into pieces of compressed data for storage in a Read-Only Memory ROM of a mobile phone. It is only required to perform card swiping through the NFC card swiping and data acquisition unit when the data is needed.

The bankcard management unit mainly manages high-security payment information such as bankcard information or the like. The embodiment of the present disclosure provides an SIM+bankcard binding security mechanism, and the unit may provide a payment support for the member card information management unit. That is, the unit is required to finish corresponding member card-payment binding with the member card information management unit. In the member card information management unit, a default payment manner for consumption in a shopping mall is set by virtue of the information of the bankcard management unit, for example, consumption with a bankcard (including a credit card, a debit card and the like) or a SIM card (a support of an operating company is required).

The bankcard management unit binds various bankcards and payment information of the user, which requires high security, for example, a high-strength password may be set, and a random code may be set to send to a telephone number set by the user, and only when all information such as the username, the password and the random code and the like is input correctly, various kinds of bankcard information may be queried. Or, under the condition that the random code is unsuitable, user account information may be opened by virtue of fingerprint identification. In an embodiment of the present disclosure, payment binding between the bankcard management unit and the user member card information may be implemented through an account interface manner such as “38************2344”, and meanwhile, for security, double-channel information payment may be adopted during card swiping payment and credit addition of the user. That is, the bankcard management unit transmits corresponding account information, the member card information management unit of the terminal transmits member card information, and the two kinds of information are transmitted to the “NFC card swiping and data acquisition unit” for data interaction with a system of the merchant after being identified respectively.

The user interaction unit is mainly arranged to perform an interface interaction with the user, the data searching unit also serves the user interaction unit, and the key function of the data searching unit provides a query function for the user. The user may interact with the system through the user interaction unit, and execute querying, management, deletion, updating and the like on information of various member cards of the user. Here, only a query method is required to be provided, and voice control or manual input may be adopted.

The card swiping interaction device of the merchant may include: a terminal interaction unit, an NFC and member card system interaction unit, a member information system management unit and a payment confirmation system.

Herein, the terminal interaction unit is arranged to transmit the member card information received from the terminal of the user to the NFC and member card system interaction unit in the card swiping process of the user. The member information and payment information may also be transmitted to the intelligent mobile terminal through the terminal interaction unit when the user gets a new member card. The terminal interaction unit may perform a data interaction with the NFC card swiping and data acquisition unit in the member card information management device of the intelligent terminal. For example, when card is swiped, the above member card information and bankcard setting information are acquired through an NFC short distance technology, and then data offloading is performed to transmit the member card information to the member card information management unit for member card information comparison, and simultaneously, the default payment manner set by the user is transmitted to the payment confirmation system, and the payment manner and the member card information are synchronously confirmed. The data offloading may be implemented through the NFC and member card system interaction unit. In such a manner, the original system of the merchant is substantially not required to be regulated, and only corresponding equipment is required to be added to transmit the data to the corresponding member card system or payment system. Therefore, the system of the merchant is only required to be upgraded, and a new management system is not required.

The NFC and member card system interaction unit may be arranged to separate the data to transmit the payment information to the payment confirmation system and transmit the member card credit information to the member card management system, or transmit the member information to the terminal interaction unit. The unit interacts with an NFC chip of the intelligent terminal for mutual data transmission through the NFC equipment at first. The interacted data may include: the member card information, the bankcard payment information, various kinds of pushed promotional information and the like.

In an exemplary embodiment, the data interaction process may include the following steps.

In step 1, NFC data interaction is performed for mutual data transmission, and a system judges a data flow direction. Step 4 is executed if the data is transmitted to the intelligent terminal. Step 2 is executed if the data is received from the intelligent terminal.

In step 2, data analysis is performed. Data analysis is performed on the received data, and the key is that data with various marks is placed in different data stacks. For example, data related to the member card information, such as a member card number, a member card type (gold card and silver card), a member card name and the like, is placed in member card temporary stack 1. Information related bankcard, such as a bankcard number, a bankcard security code and a bankcard grade name and the like, is placed in temporary stack 2, and so on. The marked data transmitted by the NFC is classified, and different data and corresponding attributes are stored in stacks for future.

In step 3, polling transmission authentication is performed on the data in the stacks. The data in the stacks are transmitted to the corresponding member card management system and payment system for authentication respectively, subsequent authentication work is implemented by the corresponding systems. Till now, the data interaction system of the merchant finishes data receiving work.

In step 4, if the system actively pushes the information to the terminal of the user, the NFC and member card system interaction unit directly packages and compresses the data into NFC data to transmit to the NFC card swiping and data acquisition unit of the intelligent terminal. Subsequent work is processed by the corresponding unit of the intelligent terminal and displayed to the intelligent terminal owner.

The member information system management unit refers to the member information management system of the merchant here, and can generate the member information, or perform a card swiping display on the transmitted member information through the “NFC and member card system interaction unit” during card swiping and credit addition. Other operations may be the same as those in the related technology, that is, the unit forms a seamless connection with the original system. The only change is that card swiping and credit addition of the user is implemented through the intelligent mobile terminal.

The payment confirmation system performs payment data processing. According to the transmitted payment information, it is required to perform NFC interaction again after selection of the user if there is no associated payment manner, If there is a set default manner, consumption credit addition is directly implemented to turn to a payment confirmation interface, and the user is asked to confirm a consumption sum and a payment bankcard number, and a payment process is finished.

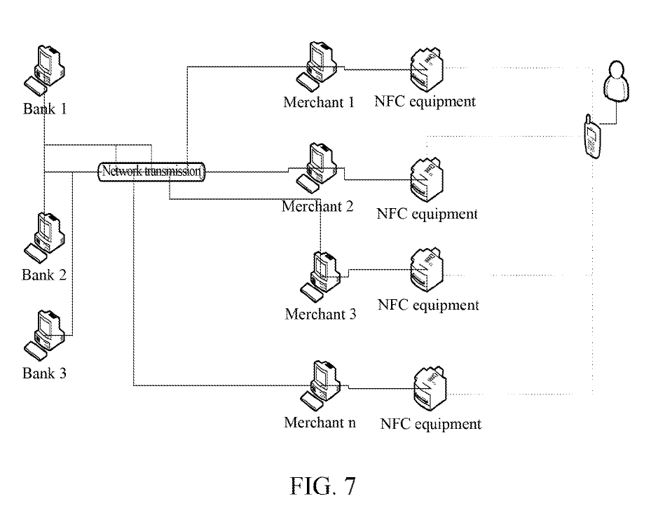

A connection diagram of the card swiping interaction device of the merchant in the embodiment may be shown in FIG. 7. As shown in FIG. 7, the card swiping interaction device of the merchant requires the merchant to purchase NFC card swiping equipment. In an exemplary embodiment, using an interface specification, i.e. NCI specification, of NFC, on one hand, seamless connection between the NFC equipment and the member card management system is implemented, so that the merchant can perform system updating with lowest cost without specially switching the system, and also re-maintaining an original database, and the merchant is only required to perform system upgrading on the basis of the existing system. On the other hand, information interaction between the intelligent mobile terminal of the user and NFC equipment of different merchants may be implemented to implement integration of all physical member cards of the intelligent mobile terminal and card swiping consumption. By upgrading the original payment system, receiving the payment information transmitted by the NFC equipment and implementing a background payment confirmation process, the user is not required to take along any bankcard, and the merchant is also prevented from a process of swiping a bankcard again for payment. Therefore, efficiency is improved, and card-free consumption of the user is really implemented.

It needs to be noted that the NCI is an interface specification of NFC, and the specification may make an equipment manufacturer integrate NFC chips of different manufacturers into equipment more easily, and the specification determines basic functions and interoperability of different NFC equipment. Before the NCI specification is proposed, each equipment manufacturer has to develop own equipment interface to solve a problem about information connection between Central Processing Units CPUs and the NFC chips, and there is no universal specification. After the NCI specification is proposed, the manufacturers may apply standard interfaces to any NFC equipment, including a mobile phone, a Personal Computer PC, a tablet computer, a printer, an electronic consumption product and the like, so that NFC equipment development periods are greatly shortened.

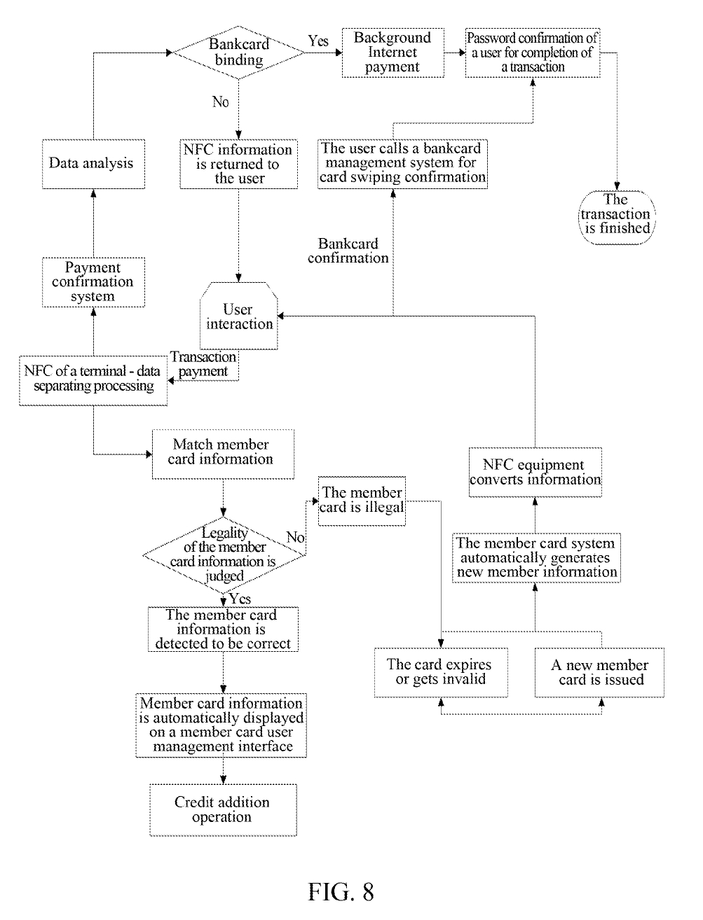

An interaction method for the two devices in the embodiment may be shown in FIG. 8. A real-time interaction process between the two devices described in the present disclosure is as follows. Information of a member card, which is owned by the user, of corresponding to a merchant, and corresponding bankcard payment information are stored in the intelligent terminal of the user. The corresponding member card information and the corresponding payment information are called when the user selects a purchased commodity and is prepared for payment, and card swiping and credit addition with the mobile phone is performed in the NFC equipment of the terminal interaction unit of the merchant, payment confirmation information is transmitted, and the interaction unit transmits the information to the NFC and member card system interaction unit and the payment confirmation system. After data analysis, on one hand, the member card data is transmitted to the member card information management system of the merchant for related operations such as credit addition and the like, herein interface display is kept consistent with previous interface display of the member card management system, thereby a secondary training is not required for a cashier, and subsequent operations are consistent with previous operations of the member management system. On the other hand, payment related information is transmitted to the payment confirmation system, and the payment confirmation system analyzes the payment information of the user. Here, a payment flow manner (but not limited to the manner) is provided. Security authentication is performed to confirm user information at first, then bankcard or SIM card correctness checking is performed, and manual confirmation is finally performed. Confirmation information is transmitted to the terminal of the user for final payment confirmation through the NFC equipment.

The equipment of the two devices perform bidirectional data transmission, that is: the user may perform card swiping and credit addition and payment by virtue of the handheld mobile terminal, the member card information and the bankcard payment information are transmitted to the member management system of the corresponding merchant, and when the user gets a new member card, the member card information management system automatically generates a piece of electronic member card information according to personal information provided by the user, and transmits the electronic member card information to the intelligent terminal of the user through the NFC equipment. The terminal of the user may prompt the user to perform payment binding according to a user setting; and for a user who has member card information already, an electronic member card corresponding to a physical member card is directly generated in the member card information system, so that member card information maintenance and updating cost of the merchant may be reduced, and smooth transition in physical card and NFC equipment switching process may also be ensured. During payment, product payment may be implemented through the terminal only by ensuring that the bankcard consumption information of the user is stored in the system. Payment manner 1: consumption payment is performed with a bankcard. Herein, the following manners may be adopted for storage of the bankcard information: (1) a corresponding card issuing bank provides an NFC card swiping information code of the corresponding bankcard, which corresponds to the bankcard; and (2) an Internet payment service is directly opened to implement paying-by-card consumption through the Internet. Payment manner 2: payment binding is performed by virtue of a SIM card. Payment manner 3: payment is performed by virtue of a shopping card issued by the merchant, and the merchant is only required to provide an NFC sequence code for the corresponding shopping card for consumption binding.

Hardware equipment required by the card swiping interaction device of the merchant includes: NFC card swiping equipment and a PC side installed with the member management system for connection. The user performs information interaction with the NFC card swiping equipment to implement bidirectional transmission with member card equipment through the intelligent mobile terminal. The NFC card swiping equipment is required to receive or transmit related information such as the member card and payment account of the user, and then transmit the transmitted information to the member card management system through processing of the “NFC and member card system interaction unit”. Herein, the NFC and member card system interaction unit is required to complete the following operations. (1) NFC identification information is generated by virtue of the member information transmitted by the member card management system and transmitted to the intelligent terminal of the user for storage. (2) NFC information received from the intelligent terminal of the user is converted and transmitted to the member card information management system, so that smooth upgrading of the member card information management system on the basis of an original member card can be ensured. (3) Encrypted account information transmitted by the terminal of the user is transmitted to the payment system of the merchant for separating, and the user is not required to swipe the credit card or the bankcard, and is only required to finally determine the sum and input the password. Moreover, all kinds of card swiping information may be transmitted through the NFC equipment after being integrated in an NFC manner or another manner.

In order to reduce the system updating cost of the merchant, the merchant may reserve the original member card management system, and is only required to add corresponding NFC equipment and add a corresponding equipment interaction interface and program interaction interface. Finally, the member card system is required to implement an integrated credit addition-payment process. For security, before payment, the user is required to confirm whether to modify the payment manner, and if NO, the system directly turns to background payment and turns to a password and confirmation code input interface for final payment.

In an exemplary embodiment, the user may further query own credit information, credit-exchanged prize list, own card swiping record in the merchant and the like through the intelligent mobile terminal. The merchant may push recent promotional information to the user through a network. The merchant may prompt some new products in a picture form to the user through the network. When a bank and the merchant cooperate to provide corresponding paying-by-bankcard consumption promotions, the user is only required to associate the corresponding bankcard for consumption, therefore great convenience is brought.

In the embodiment, one-step consumption of the consumer of the merchant is finished through the device for the terminal and the card swiping interaction device for the merchant. The consumer of the merchant is not required to take along multiple member cards, and also not required to look for different bankcards in the wallet for card swiping consumption during consumption, and may finish all consumption only by taking along the intelligent terminal after setting. Simply speaking, the consumer is only required to click a confirmation button. All processing processes and security protection are implemented by the intelligent terminal and the card swiping interaction device for the merchant.

According to the member card application device for the intelligent terminal and card swiping interaction device for the merchant provided by the embodiments, the user may electronically integrate all of her/his member cards of corresponding merchants into the handheld intelligent terminal, and during card swiping each time, credit addition consumption may be implemented only by calling the member cards of the corresponding merchants. Moreover, the corresponding member cards are bound with consumption manners selected by the user, so that member credit addition of the user may be implemented, at the same time, payment processes may also be directly implemented, and finally, the user is only required to confirm the payment sum and payment manner. Therefore, the user is not required to specially take along bankcards for consumption, and instead, both member cards and payment bankcards are integrated into one system for one-step consumption.

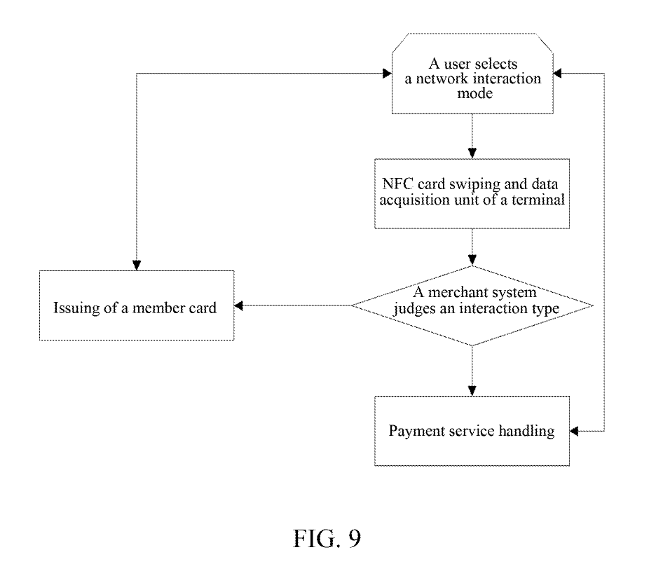

In addition, the electronic card management method provided by the present disclosure may also be implemented by virtue of the network, for example, for an application scenario where a user of a merchant such as an airline company or the like may not have the time to get a member card on the spot. The merchant may publish an NFC code through the network, and the user scans the NFC interaction code on a PC (or by other means) to obtain member information, or obtains the NFC code in a manner of surfing the Internet through the terminal to store and maintenance by the terminal. The NFC code may be directly used and credits are added when booking a ticket, Data are transmitted mutually with the airline company remotely through the network serving as a medium, and a Point-to-Point P2P security connection or the like is established for a bank payment service. Detailed processes for network-based member authentication and payment operation may be shown in FIG. 9.

Although the alternative embodiments of the present disclosure has been exemplarily disclosed, those skilled in the art should recognize that it is also possible to make various improvements, additions and replacements, therefore the scope of the present disclosure shall not be limited to the abovementioned embodiments.

### INDUSTRIAL APPLICABILITY

According to the electronic card application method and device adopting the above technical solutions, the user identity information and the corresponding encrypted function information are both stored in the mobile terminal, and the mobile terminal may send the information to the corresponding service equipment. The mobile terminal may further provide the user confirmation interface corresponding to the encrypted function information for the user after the service equipment authenticates the information. The mobile terminal notifies the service equipment to make the service equipment execute the operation corresponding to the encrypted function information under the condition that the confirmation of the user is obtained. In such a manner, the user identity information and some function information corresponding to the identity information are all integrated in the mobile terminal such as the mobile phone of the user or the like. During application, the service equipment may automatically perform a security authentication on the identity information and the corresponding function information, and then automatically ask for the confirmation of the user. The user can execute an operation with a legal identity to complete a corresponding function without sequentially showing a corresponding identity card and function card. Therefore, efficiency and convenience of applying an electronic card by the user are greatly improved. Thus, the present disclosure has very strong industrial applicability

What is claimed is:

1. An electronic card application method, comprising:
setting user identity information and encrypted function information corresponding to the user identity information in a mobile terminal in an electronic card form respectively;
sending, by the mobile terminal, the user identity information and the encrypted function information to service equipment;
providing, by the mobile terminal, a user confirmation interface corresponding to the encrypted function information for a user under a condition that the user identity information and the encrypted function information pass an authentication of the service equipment; and
notifying, by the mobile terminal, the service equipment to execute an operation corresponding to the encrypted function information under a condition that a confirmation of the user is obtained.

2. The electronic card application method according to claim 1, wherein a manner of sending, by the mobile terminal, the user identity information and the encrypted function information to service equipment comprises at least one of the following manners:
sending through Near Field Communication, NFC, equipment, sending through Bluetooth equipment, sending through infrared equipment and sending through Wireless Fidelity, WIFI, equipment.

3. The electronic card application method according to claim 1, wherein the user confirmation interface comprises a password input field.

4. The electronic card application method according to claim 1, wherein after providing, by the mobile terminal, the user confirmation interface corresponding to the encrypted function information for the user, the method further comprises:
providing a setting interface for the user to re-determine encrypted function information corresponding to the user identity information according to an input setting of the user under a condition that the confirmation of the user is not obtained.

5-10. (canceled)

11. The electronic card application method according to claim 1, wherein,
the user identity information is an identifier that can identify an identity of the user; and the encrypted function information includes one or more pieces of the following information: bankcard payment function information, Subscriber Identity Module SIM card payment function information, or room unlocking function information, member information query function information, gift exchange function information and service changing function information.

12. An electronic card application method, comprising:
receiving, by service equipment, user identity information and encrypted function information corresponding to the user identity information, which are sent by a mobile terminal;
notifying the mobile terminal to provide a corresponding user confirmation interface for a user under a condition that the user identity information and the encrypted function information pass an authentication of the service equipment; and
executing, by the service equipment, an operation corresponding to the encrypted function information under a condition that a confirmation of the user is obtained.

13. The electronic card application method according to claim 12, wherein, a manner of receiving, by service equipment, user identity information and encrypted function information corresponding to the user identity information, which are sent by a mobile terminal, comprises at least one of the following manners:
sending through Near Field Communication, NFC, equipment, sending through Bluetooth equipment, sending through infrared equipment and sending through Wireless Fidelity, WIFI, equipment.

14. The electronic card application method according to claim 12, wherein, after the service equipment receives the user identity information and the encrypted function information corresponding to the user identity information, which are sent by the mobile terminal, the method further comprises:
the service equipment comparing the received user identity information with an identity information table of all registered users maintained in the service equipment, and if the information is matched, determining that an authentication is passed; or,
the service equipment comparing the received user identity information with the identity information table of all registered users maintained in the service equipment, and if the information is matched and a security authentication on the user identity information and the corresponding encrypted function information is passed, determining that the authentication is passed.

15. The electronic card application method according to claim 12, wherein, the service equipment is payment equipment, and under a condition that a confirmation of the user is obtained, the service equipment executing an operation corresponding to the encrypted function information comprises:
the payment equipment receiving a password input by the user from the mobile terminal, and after the password is authenticated to be correct, the payment equipment completing a deduction operation over a bankcard.

16. The electronic card application method according to claim 15, wherein, after the deduction operation over the bankcard is completed, the method further comprises:
completing a member card credit upgrading operation.

17. An electronic card application device, arranged in a mobile terminal, comprising a configuration unit, a sending unit, a provision unit and a terminal notification unit, wherein:
the configuration unit is arranged to set user identity information and encrypted function information corresponding to the user identity information in the mobile terminal in an electronic card form respectively;
the sending unit is arranged to send the user identity information and the encrypted function information to service equipment;
the provision unit is arranged to provide a user confirmation interface corresponding to the encrypted function information for a user under a condition that the user identity information and the encrypted function information pass an authentication of the service equipment; and
the terminal notification unit is arranged to notify the service equipment to execute an operation corresponding to the encrypted function information under a condition that a confirmation of the user is obtained.

18. The electronic card application device according to claim 17, wherein the user confirmation interface provided by the provision unit comprises a password input field.

19. The electronic card application device according to claim 17, wherein the provision unit is further arranged to provide a setting interface for the user to re-determine encrypted function information corresponding to the user identity information according to an input setting of the user under a condition that the confirmation of the user is not obtained.

20. The electronic card application device according to claim 17, wherein the sending unit is arranged to send the user identity information and the encrypted function information to the service equipment in at least one of the following manners:
sending through Near Field Communication, NFC, equipment, sending through Bluetooth equipment, sending through infrared equipment and sending through Wireless Fidelity, WIFI, equipment.

21. An electronic card application device implementing the electronic card application method according to claim 12, arranged in service equipment, comprising a receiving unit, an equipment notification unit and an execution unit, wherein:
the receiving unit is arranged to receive user identity information and encrypted function information corresponding to the user identity information, which are sent by a mobile terminal;
the equipment notification unit is arranged to notify the mobile terminal to provide a corresponding user confirmation interface for a user under a condition that the user identity information and the encrypted function information pass an authentication of the service equipment; and
the execution unit is arranged to execute an operation corresponding to the encrypted function information under a condition that a confirmation of the user is obtained.
